(19) United States
(12) Patent Application Publication
(10) Pub. No.: US 2006/0032753 A1
(43) Pub. Date: Feb. 16, 2006

(54) Electrolytic-water supplying faucet

(76) Inventor: Yu-yu Hsien, Chang Hua Hsien (TW)

Correspondence Address: Yu-yu Hsien, 235 Chung - Ho, Box 8-24, Taipei, TW

(21) Appl. No.: 10/916,573

(22) Filed: Aug. 12, 2004

(51) Int. Cl. C02F 1/46

(52) U.S. Cl. 204/660

(57) ABSTRACT

A faucet is capable of supplying electrolytic water. The faucet comprises a cold water supply tube for supplying unprocessed water; a hot water supply tube; a water mixing valve for mixing cold and hot waters from the cold water supply tube and hot water supply tube; a faucet body connected to the water mixing valve; a clean water control valve installed in the faucet body from a valve groove; a valve groove in the faucet body and having an inner water guide channel which is communicable to a water supply channel below the faucet body; a water supply opening is communicated to a lateral side of the valve groove so as to guide water to a water electrolyzing machine. The unprocessed water flows to a water filer for filtering; then to the clean water control valve; and then to the water electrolyzing machine to get acid water or alkaline water.

### FIELD OF THE INVENTION

The present invention relates to faucets, and particular to an electrolytic-water supplying faucet, wherein a cold water supply tube is used to supply unprocessed water. Then the unprocessed water flows to a water filer for filtering; then to the clean water control valve; and then to the water-electrolyzing machine to get acid water or alkaline water.

### BACKGROUND OF THE INVENTION

Electrolytic water is helpful to human health. Thereby, more and more water-electrolyzing machines are installed in home, and particular to in kitchen. Since the electrodes in the water-electrolyzing machine must not be polluted so as to effect the functions thereof. In some application, reverse osmosis machines are used in the water supply system. However, the reverse osmosis machine has filtered some minerals from the water. The minerals are necessary to the water-electrolyzing machine. Thereby, the water-electrolyzing machine cannot be used with the reverse osmosis machine and thus it needs to add with a water filter.

The water-electrolyzing machine serves to adjust the PH values, or electrolyze or reverse wash, etc. It needs to display the operation conditions. In general, the water is supplied to a water filter and then to the water-electrolyzing machine.

In the prior art, the faucet is independent from the water-electrolyzing machine and filters. In installation, some tubes are added to the system and some holes must be made in the installation process.

The water-electrolyzing machine has two water outlets for supplying acid water and alkaline water. However, the working table is formed with holes for installing tubes of the water-electrolyzing machine. The work of installing tubes for the water-electrolyzing machine is inconvenient and the pipelines of the system occupy a larger space in kitchen. Moreover, some switches for controlling water flow are added. It further increases the cost.

Moreover, these pipes, switches and holes are arranged disorderly so as to present an unbeautiful outlook and hinder the work, such as cooking.

### SUMMARY OF THE INVENTION

Accordingly, the primary object of the present invention is to provide a To achieve above objects, the present invention provides a electrolytic-water supplying faucet which comprises a cold water supply tube for supplying unprocessed water; a hot water supply tube for supplying hot water; a water mixing valve connected to the cold water supply tube and the hot water supply tube for mixing cold and hot waters from the cold water supply tube and hot water supply tube; a faucet body connected to the water mixing valve; a clean water control valve locked into the faucet body from a valve groove; a valve groove in the faucet body and having an inner water guide channel which is communicable to a water supply channel below the faucet body; a water supply opening is communicated to a lateral side of the valve groove so as to guide water to a water electrolyzing machine. When the unprocessed water flows out of the faucet body to the clean water control valve; then the unprocessed water flows to a water filer for filtering; then the filtered clean water flows to the clean water control valve; if the clean water control valve is opened, water will further flow into the water supply channel to the water supply opening at the lateral side of the valve groove so as to be guided to the water electrolyzing machine to get acid water or alkaline water.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is an assembled perspective view of the present invention.

FIG. 3 is a transversal cross section view of the present invention.

FIG. 4 is a longitudinal cross section view of the present invention.

FIG. 4A is a bottom view of the present invention.

FIG. 5 is an exploded perspective view of the second embodiment of the present invention.

FIG. 6 is an assembled view of the second embodiment of the present invention.

FIG. 7 is a transversal cross section view of the second embodiment of the present invention.

FIG. 8 is a longitudinal cross section view of the second embodiment of the present invention.

FIG. 8A is a bottom view of the second embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

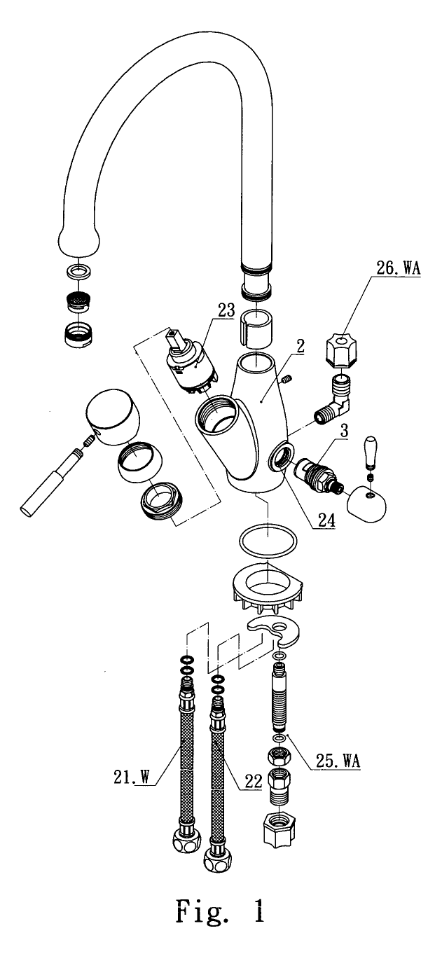

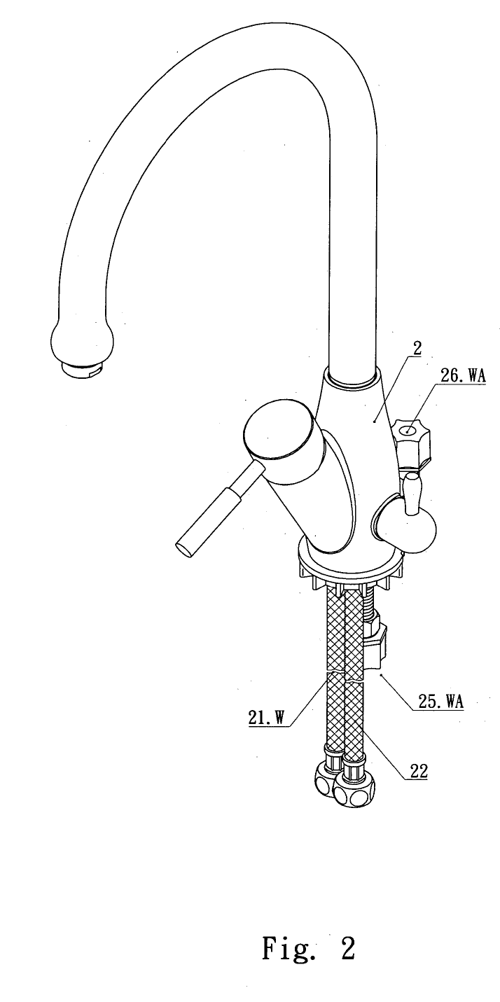

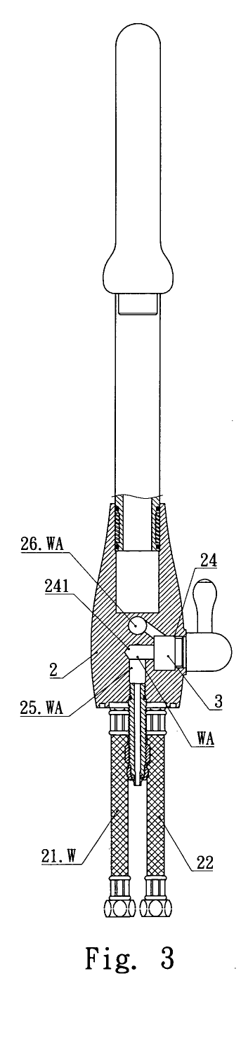

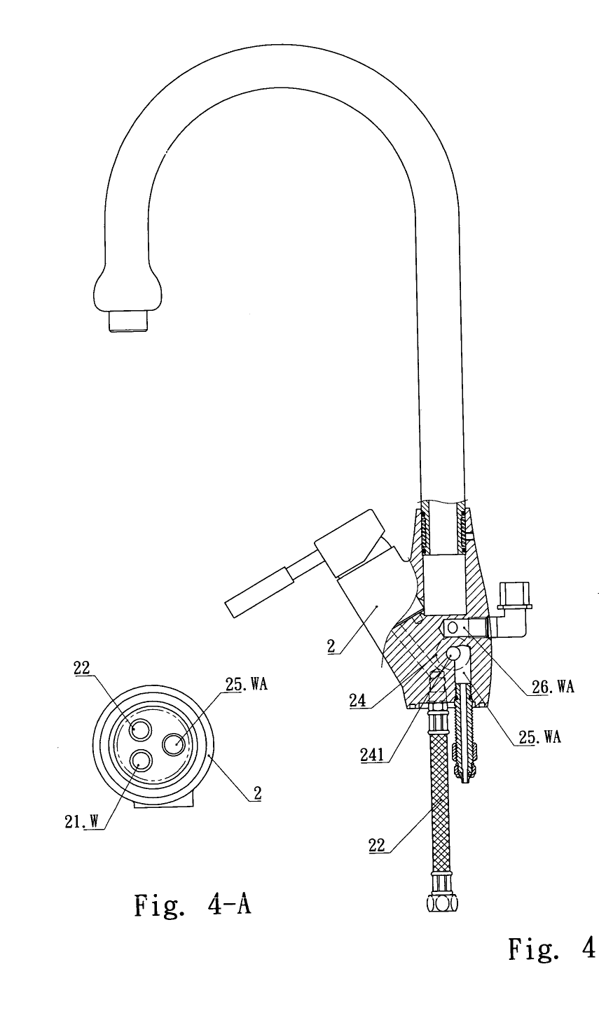

With reference to FIGS. 1, 2, 3 ,4 and 4A, the structure of the present invention is illustrated. The present invention has the following elements.

A cold water supply tube 21 is included. Unprocessed water W flows in the cold water supply tube 21. In the present invention, the unprocessed water is water directly supplying into the faucet body from a water sources which is not processed by such as filtering, cleaning, electrolyzing, etc.

A hot water supply tube 22 is included.

A water mixing valve 23 is connected to the cold water supply tube 21 and the hot water supply tube 22 for mixing cold and hot water from the cold water supply tube 21 and hot water supply tube 22.

A faucet body 2 is connected to the water mixing valve 23.

A clean water control valve 3 is installed into the faucet body 2 from a valve groove 24.

The valve groove 24 has an inner water guide channel 241 which is communicable to a water supply channel 25 below the faucet body 2.

A water supply opening 26 is communicated to a lateral side of the valve groove 24 so as to guide water to a water-electrolyzing machine (not shown). Thereby, the unprocessed water W flows out of the faucet body 2 to the clean water control valve 3. Then the unprocessed water W flows to a water filer (not shown) for filtering. Then the filtered clean water WA flows to the clean water control valve 3. If the clean water control valve 3 is opened, water WA will further flow into the water supply channel 25 to the water supply opening 26 at the lateral side of the valve groove 24 so as to be guided to the water-electrolyzing machine to get acid water or alkaline water. Thereby, it is only necessary to adjust the opening or closing of the clean water control valve 3. Thus, the user can acquire acid water or alkaline water.

Moreover, in the present invention, the clean water control valve 3 may has a handle for controlling the opening and closing operation of the clean water control valve 3. The water-electrolyzing machine has two openings for supplying acid water and alkaline water, respectively.

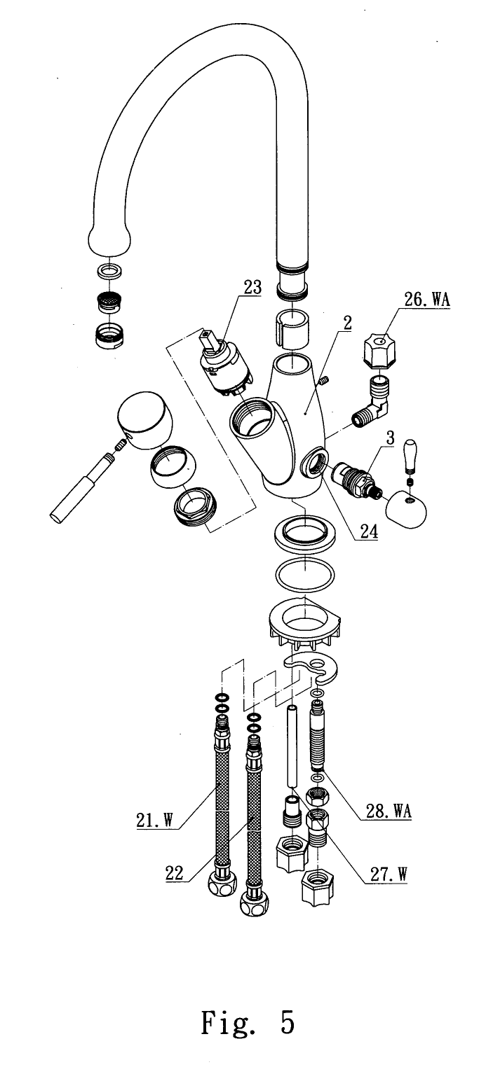

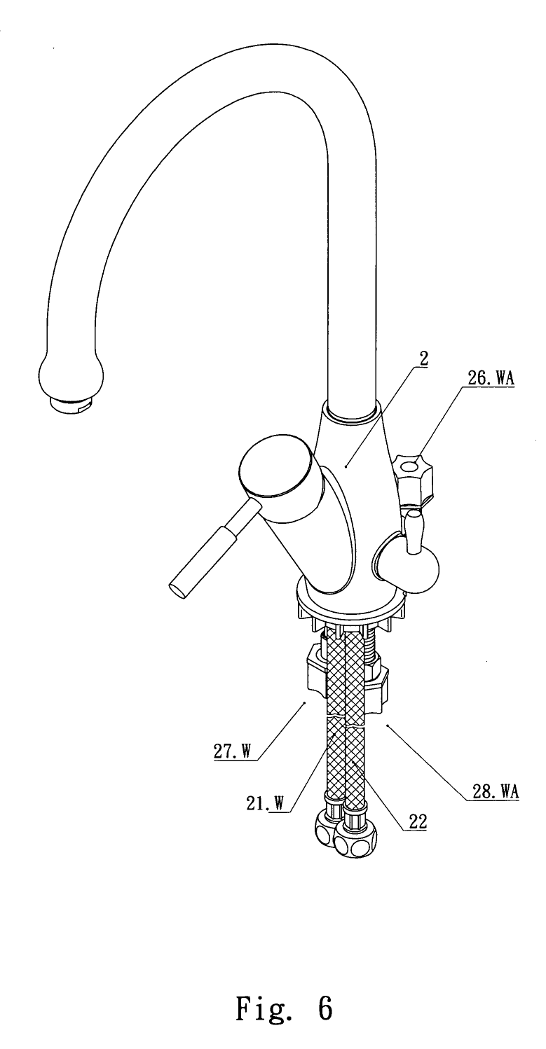

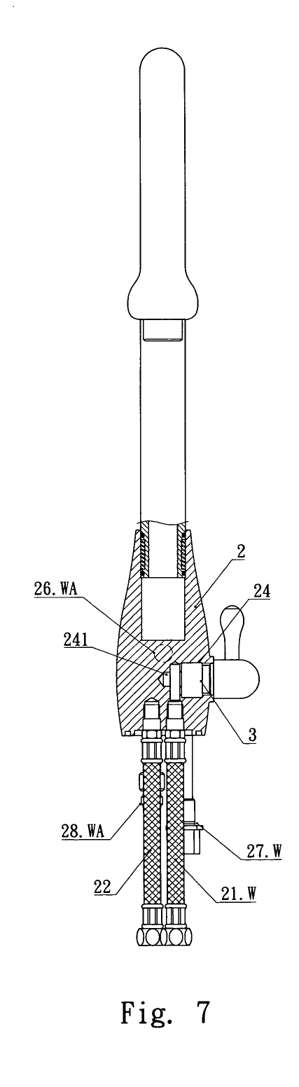

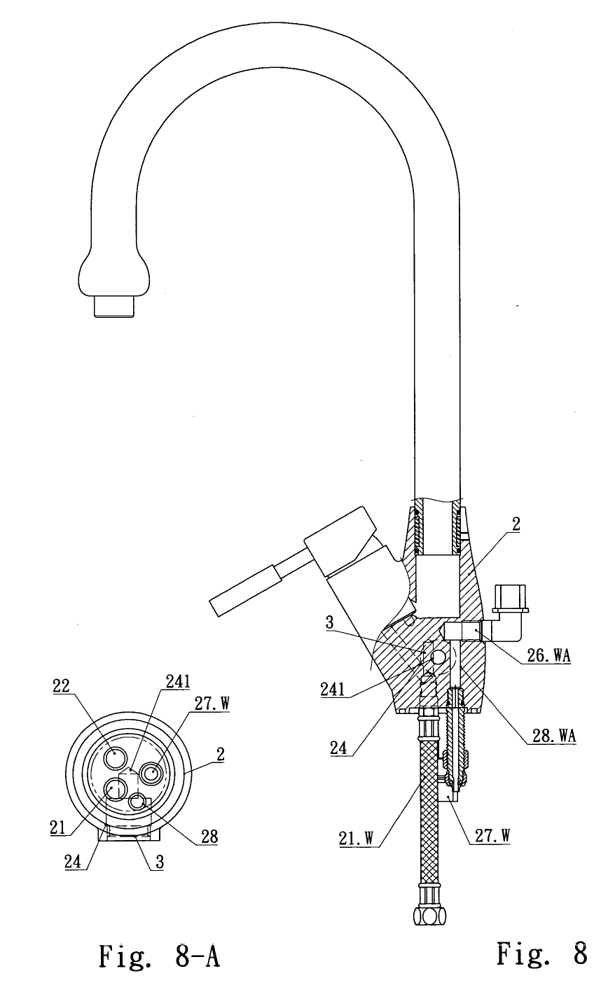

With reference to FIGS. 5, 6, 7, 8, and 8A, another embodiment of the present invention is illustrated. The differences of this embodiment from the previous one are that a water output tube 27 is connected to the clean water control valve 3 for supplying water to the water filter (not shown) and a water input tube is used to supply filtered clean water from the water-electrolyzing machine to the faucet body 2. Other structure of this embodiment is identical to the previous one and thus the detail will not described herein.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A electrolytic-water supplying faucet comprising:
a cold water supply tube for supplying unprocessed water;
a hot water supply tube for supplying hot water;
a water mixing valve connected to the cold water supply tube and the hot water supply tube for mixing cold and hot waters from the cold water supply tube and hot water supply tube;
a faucet body connected to the water mixing valve;
a clean water control valve installed in the faucet body from a valve groove;
a valve groove in the faucet body and having an inner water guide channel which is communicable to a water supply channel below the faucet body;
a water supply opening communicated to a lateral side of the valve groove so as to guide water to a water electrolyzing machine;
wherein the unprocessed water flows out of the faucet body to the clean water control valve; then the unprocessed water flows to a water filer for filtering the unprocessed water; then the filtered clean water flows to the clean water control valve; if the clean water control valve is opened, water will further flow into the water supply channel to the water supply opening at the lateral side of the valve groove so as to be guided to the water electrolyzing machine to get acid water or alkaline water.

2. The electrolytic-water supplying faucet as claimed in claim 1, wherein the clean water control valve has a handle for controlling the opening and closing operation of the clean water control valve.

3. The electrolytic-water supplying faucet as claimed in claim 1, wherein the water electrolyzing machine has two opening for supplying acid water and alkaline water, respectively.

4. The electrolytic-water supplying faucet as claimed in claim 1, further comprising:
a water output tube connected to the clean water control valve for supplying water to the water filter; and
a water input tube for supplying the filtered clean water from the water filter to the faucet body.
